(19) United States
(12) Patent Application Publication
(10) Pub. No.: US 2006/0218025 A1
(43) Pub. Date: Sep. 28, 2006

(54) Variable pricing module

(76) Inventors: John M. Miller, Del Mar, CA (US); Shoichiro Christopher Masui, San Diego, CA (US)

Correspondence Address: DAVID R PRESTON & ASSOCIATES APC, 5850 OBERLIN DRIVE, SUITE 300, SAN DIEGO, CA, 92121, US

(21) Appl. No.: 11/390,272

(22) Filed: Mar. 27, 2006

Related U.S. Application Data
(60) Provisional application No. 60/665,535, filed on Mar. 28, 2005.

(51) Int. Cl. G06Q 10/00

(52) U.S. Cl. 705/5

(57) ABSTRACT

The present invention recognizes that a need exists for timely, accurate, and thorough methods, systems, articles of manufacture and methods of doing business in the context of information retrieval and analysis, particularly for businesses dealing in goods and services wherein price fluctuations are common and rapid. The present invention addresses these needs by providing appropriate systems, methods, articles of manufacture and methods of doing business. One aspect of the present invention is a method for obtaining results from a query, including: providing a query to a server by a client system; obtaining data relating to the query; optionally storing the data in whole or in part on the server; formulating a response to the query using software and the data; optionally notifying a client remote location of the existence of the results; and obtaining the results through the client system.

This application claims benefit of priority to U.S. Provisional Application No. 60/665,535 filed Mar. 28, 2005, naming Miller et al. as inventors, which is incorporated by reference in its entirety herein.

### TECHNICAL FIELD

The present invention relates generally to the field of information retrieval and analysis, particularly systems, methods, and methods of doing business. More particularly, the present invention utilizes internet technology and software to allow a client to submit a query to which results are obtained. The results of that query may then be used to determine the price offered by a host. The results of the query and/or the price offered by the host may then be communicated to the client.

### BACKGROUND

Information retrieval and analysis technology has improved tremendously in recent years. However, systems and methods for providing accurate, timely, and thorough search results are lacking. Individual commercial search engines are not always accurate, and are often hampered by their own limited access to information. In addition, this limited access to information creates a need to repeat searches on several engines, which in turn increases the time required for the search. In some fields, search results are only accurate for a short period due to rapid price fluctuations, and thus the longer it takes to obtain search results, the less accurate the search becomes. Accuracy can be further compromised by the time required for data analysis, as comparing the various search results to find the most appropriate option extends the time required to obtain relevant information. Fields in which the need for quality information retrieval and analysis are most pronounced are, for example, business areas in which prices fluctuate rapidly due to variability of margins or availability of resources.

### BRIEF DESCRIPTION OF THE FIGURES

FIG. 1 depicts a chart of a Variable Pricing Module in the context of airline flight reservations.

FIG. 2 depicts a chart of a Variable Pricing Module in the context of hotel reservations.

FIG. 3 depicts a chart of a Variable Pricing Module in the context of computer memory.

FIG. 4 depicts a chart of a Variable Pricing Module in the context of printer ink or toner.

### SUMMARY

The present invention recognizes that a need exists for timely, accurate, and thorough methods, systems, articles of manufacture and methods of doing business in the context of information retrieval and analysis, particularly for businesses dealing in goods and services wherein price fluctuations are common and rapid. The present invention addresses these needs by providing appropriate systems, methods, articles of manufacture and methods of doing business.

One aspect of the present invention is a method for obtaining results from a query. The method includes: providing a query to a server through a client system; obtaining data relating to the query by using at least in part the query parameters to search a plurality of reference locations; optionally storing the data in whole or in part on the server; using a software application and the data to formulate a response to the query; and communicating the results through the client system.

A second aspect of the present invention is a method of doing business that includes: providing a system for determining a price; accepting a query from a client system; obtaining data relating to the query; optionally storing the data in whole or in part on the server; using a software application and the data to formulate a response to the query; optionally notifying a client remote location of the existence of the results; and communicating the results through the client system.

A third aspect of the present invention is data obtained using a method of the present invention and database of data obtained using a method of the present invention.

A fourth aspect of the present invention is results obtained using a method of the present invention and a database of results obtained using a method of the present invention.

A fifth aspect of the present invention is a database of data and results obtained using a method of the present invention.

A sixth aspect of the present invention is a system for obtaining results for a query. The system includes: a server comprising a server processor, a server database, a link to a reference location, and a link to a client system. Preferably, said query is provided through the client system to the server and data relating to the query is obtained using at least in part said query. The data is optionally stored in whole or in part on said server. A response to the query is generated using, at least in part, said data, and preferably, the results are communicated through said client system.

### DETAILED DESCRIPTION OF THE INVENTION

Definitions

Unless defined otherwise, all technical and scientific terms used herein have the same meaning as commonly understood by one of ordinary skill in the art to which this invention belongs. Where a term is provided in the singular, the inventors also contemplate the plural of that term.

A “system” refers to components, such as but not limited to hardware and software, operably linked to perform a function. The components need not be located in a centralized location or geographical area, particularly where communication links, such as through telecommunications, telepathy or the internet, are available and used.

A “server” refers to one or more servers as that term is currently known in the art or is later developed. A server includes the hardware and software appropriate for a server to function effectively for a given purpose.

A “processor” refers to one or more processors as that term is currently known in the art or is later developed.

A “reference location” refers to one or more entities or loci on an information system that are in possession, have access to or otherwise have available information or data useful in a system, method or other aspect of the present invention.

A “client system” refers to any suitable mechanism for inputting a query, such as but not limited to computers, telephony including Telephone Device for the Deaf (TDD) equipment, voice recognition software, touchscreen, or keypads.

A “query” refers to a question or request for information, from a source such as a client or a client system.

A “client” refers to one or more entities that directly or indirectly provide a query.

A “host” refers to one or more entities that employ the Variable Pricing Module.

“Linking” refers to the process of identifying and optionally making a link, such as but not limited to an internet link, telephonic or telepathic link, between two locations, preferably to open lines of communication between the two locations. For example, a client system can be linked to a server.

“Data” refers to information in any form or format, preferably in a computer storage medium in a machine readable format and more preferably provided arranged in a database. Data refers to information in any form, such as letters, symbols, numbers or combination thereof. Preferably, data refers to numbers or numbers in combination with letters.

A “database” refers to an arrangement of data, preferably in at least one machine readable format on at least one machine at at least one location. The data can be arranged in any appropriate way using, for example, database management software as is known in the art or as commercially available. The data can be arranged, for example, numerically, alphabetically or in the order in which it was entered into the database. A database can be maintained and searched using software commercially available and as known in the art.

A “response” refers to an answer to a query. A response may be a partial or whole answer to a query, or can be an indication that an answer to a query is not available. A response can be provided in any format or form, but is preferably provided in a form useful to a user, be that a machine or human.

A “machine readable format” refers to a format that is useable by a machine, such as a central processing unit or a processing unit. The machine readable format can be any appropriate format, such as paper, magnetic medium or polymers such as cycloolifin polymers or copolymers. Data is provided on a machine readable format in an appropriate manner. For example, data on a paper machine readable format can be provided as marks or holes on the paper, or a combination thereof.

A “URL” or Uniform Resource Locator, refers to a unique pointer to data or a location on the World Wide Web that can contain information about protocol (such as HTTP), the Internet Server Hostename, the directory or the file name of data or the location.

A “HTTP” or Hypertext Transfer Protocol, refers to an Internet communications protocol usually used with a URL to communicate between a web browser and a web server.

Introduction

The present invention recognizes that a need exists for timely, accurate, and thorough methods, systems, articles of manufacture and methods of doing business in the field of information retrieval and analysis, particularly for businesses dealing in goods and services wherein price fluctuations are common and rapid. The present invention addresses these needs by providing appropriate systems, methods, articles of manufacture and methods of doing business.

As a non-limiting introduction to the breadth of the present invention, the present invention includes several general and useful aspects, including:
1) a method for obtaining results of a query;
2) a method of doing business using at least one aspect of the present invention;
3) data obtained using a method of the present invention and database of that data obtained using a method of the present invention;
4) results obtained using a method of the present invention and a database of those results obtained using a method of the present invention;
5) a database of data and results obtained using a method of the present invention; and
6) a system for obtaining results of a query.

The previously described aspects of the invention, as well as others described herein, can be achieved by using the system, methods, articles of manufacture, compounds and compositions of matter described herein. To gain a full appreciation of the scope of the present invention, it will be further recognized that various aspects of the present invention may be combined to achieve desirable embodiments of the invention.

1. A Method for Obtaining Results from a Query

The present invention includes a method for obtaining the results of a query. The method includes: providing a query to a server through a client system; obtaining data relating to the query by using, at least in part, the query parameters to search a plurality of reference locations; optionally storing the data in whole or in part on the server; using a software application and the data to formulate a response to the query; optionally notifying a client system of the existence of the results; and communicating the results through a client system.

Server

The server can be one or more servers in a single location or in multiple locations. For example, a server can include two distinct servers operably linked in the same or different geographical locations. A server, or a plurality of servers, are preferably from a single internet location, but that need not be the case. A server preferably includes appropriate hardware and software, such as the Variable Pricing Module software, for an intended use.

Preferably, the server is a secure server. Servers can be made secure using hardware and software commercially available. Additionally, the server includes encryption software such that communications entering or exiting the server are encrypted. Encryption hardware and software are commercially available.

Server Database

A server database is at least one database of data located on one or more servers in one or more locations. The location can be a geographic location or loci on an information system, such as a server or the internet. The database can be generated, maintained, used or manipulated using methods, hardware and software known in the art. In one aspect of the present invention, the data can be organized into classifications of use. For example, a database can include sub-databases that are useful for one or more applications and the sub-databases can be utilized for one or more applications.

Server Processor

A server processor can be one or more processors in a single location or in multiple locations. For example, a processor can include two distinct processors operably linked in the same or different geographical locations. A processor preferably includes appropriate hardware and software, such as the Variable Pricing Module software, for an intended use.

Link

Links between the server, client and reference location can be any appropriate link, such as telephonic, telepathic, via the internet, optically based, or other appropriate method, means, hardware or software. The link is preferably an appropriate link that allows the efficient, rapid and accurate transmission of information from one location to another. Preferably, links between the server(s), client(s) and reference location(s) are via the internet, are preferably secure and are more preferably encrypted.

Reference Location

Reference locations can be a single or multiple locations, such as physical locations or internet locations. Reference locations are preferably a single physical location at a single internet location, but that need not be the case. Reference locations are preferably remote to the server site, but that need not be the case. A reference location preferably includes a reference server that includes appropriate hardware and software for an intended use. A reference location preferably includes at least one database that is in one or more locations. Preferably, a reference database is provided as one or more server databases in a single location or multiple locations. Preferably, a reference database comprises data organized into classifications of use and is remote to the server and the client.

Client Location

A client can be located in one or more physical locations or internet locations. Preferably, a client is at a single geographical and internet location, but that need not be the case. Preferably, the client location is remote to the server and the partner location. A client location preferably includes appropriate hardware and software for an intended use.

Client System

A client system can be any system, component, hardware, or software appropriate for accepting a query from a client and communicating with a server. In a preferred aspect of the present invention, a client has an assigned URL. That client URL is preferably located on the server rather than being located at a client location or a partner location. A client URL preferably has the look and feel of a home page that identifies the client and the server or server location. The client URL is preferably designed to efficiently interact with the client, client server, client database and optionally the partner, partner server and partner database.

Query

A query is preferably provided by a client system to a server, more preferably through a client URL to a secure and optionally encrypted server. The query can be provided in any form or format, such as any appropriate tangible or intangible medium of expression. Preferably, the query is provided in a machine readable format and is provided to a server via an appropriate means of communication, such as the internet. The query can be entered or generated by an operator, such as a machine or a human operator. A query entered in one form or format can be converted to another form or format. For example, a human operator can enter a query in a human language, such as English or French, and a machine can convert that query into an appropriate machine language. This conversion preferably takes place on the server, but that need not be the case.

A query can be entered by any appropriate method, means or device, preferably using a keyboard. In one preferred aspect of the present invention, a human operator inputs a query into a form, such as a virtual form, located on a client URL. The use of forms makes the systems and methods of the present invention efficient to use, maintain and operate due to consistencies. In one preferred aspect of the present invention, a query, such as a query input into a form on client URL, is converted to an alphanumeric string. This conversion can be made using hardware and software known in the art.

In one preferred aspect of the present invention, the query is entered onto a server, where it is stored for archiving purposes and to indicate that a query, or a job, has entered the server. Notice of an incoming query is generated by the server, which then optionally catalogues, maintains and manages the query and the associated job, preferably using appropriate hardware and software. Databases of such queries and jobs can be made and maintained using appropriate hardware and software.

Data

Once a query is provided to the server, data for formulating an answer or response to a query is identified and utilized. Data can be of any form and in any location, but is preferably located at least in part on the server and is preferably in the form of a database. Data can also be located at a client location or reference location. Data can also be located elsewhere on the internet, such as in databases provided by government entities or private entities. Some databases may be provided free of charge or may be provided for charge. Data can also be in the form of records, such as hard copies or microfilm copies of records. Data in this form is preferably searched using human searchers and investigatory methods.

A query is used to generate a response by searching data from a variety of sources. Preferably, a database, preferably a database on a server, is used. Preferably, a query in an electronic form is used to search a database on a server using appropriate hardware and software. If the data needed to formulate an answer or response to a query is not on the server or server database, then alternative sources of data can be utilized. Preferably, databases on reference locations are utilized via linking the server with the reference location. The reference location is queried using appropriate hardware and software. Alternative sources of data include the internet, for-charge databases, and public and private records. These alternative sources of data can be utilized as needed using appropriate methods, hardware and software. In one aspect of the present invention, human searchers are used to obtain data from hard-copy, microfilm or other data that is not in a format or form appropriate for computerized searching.

Preferably, all or part of the data generated in formulating a response to a query is stored on the server, preferably in the form of a database. In that way, the server database continually grows and is focused on the type of query that is provided to the server.

Response

The data are used to formulate a response to a query. The response can be provided in any form or format, but is preferably provided in a standard format and is preferably provided in an electronic form. The response is preferably provided on the client system so that a client can readily obtain and utilize the results. In one aspect of the present invention, results are tabulated and preferably stored as a database. The database can be maintained on the server or other location as seen fit by the client.

In one aspect of the present invention, the results and optionally data are provided to the client system by appropriate methods of communication, such as by hard copy, telecommunications or the internet. Preferably, the results and data are provided to client via the internet using the client URL that links the client system to the server. The results and data are preferably integrated into an existing database, or used to begin a new database or sub-database. These databases or sub-databases are preferably stored, at least in part, on the server in a location suitable for the client to access, such as through the client system.

Communicating Results

Results can be communicated to the client using the same or similar routes that the query was provided to the server. Preferably, the results are communicated by contacting the client system using appropriate methods and means, such as the client URL. Alternatively, the results are stored on the server, preferably on an appropriate client URL, such that a client can easily access requested information, such as results. The results can be stored in the form of a database for easy modulation and use. Results can be transferred to an appropriate entity by way of appropriate methods of communication, but are preferably electronically transferred, and more preferably by the internet.

Fields of Use

The present invention can be used for a variety of purposes, particularly fields in which the need for quality information retrieval and analysis are most pronounced, for example, business areas in which prices fluctuate rapidly due to variability of margins or availability of resources. Fields of use that are particularly well suited for the present invention include but are not limited to: providing airline flight reservations, providing hotel reservations, sales of computer memory, and sales of printer ink and toner.

2. Method of Doing Business

The present invention also includes a method of doing business that includes: providing a system whereby a client can provide a query to a server through a client system; obtaining data relating to the query; optionally storing said data in whole or in part on the server; and formulating a response to the query. This aspect of the present invention is one aspect of the commercialization of the methods, systems and databases of the present invention. Post-solution activity of the methods is provided as providing notice of the results and providing the results themselves to an appropriate entity, such as a client. Preferably, the billing or invoicing for the purchase or use of goods or services of the present invention is automatically monitored and made using appropriate hardware and software such as that commercially available, although more traditional accounting methods can be utilized.

In one aspect of the present invention, billings are made automatically when a client provides a query or otherwise requests goods or services. Alternatively, billings are made when results are provided or obtained by a client or other appropriate entity. Billings or invoices can be provided to an appropriate entity using any appropriate method of communication, but are preferably made electronically, such as by e-mail. Payment can be made using any appropriate method, but is preferably electronic, such as via e-mail, electronic banking, electronic credit transactions or by credit or debit accounts.

3. Data and Databases of Data

The present invention also includes data obtained using a method of the present invention, preferably provided in an appropriate format. Data obtained using a method of the present invention can be provided as a database, wherein a database that includes at least in part data obtained using a method of the present invention is itself an aspect of the present invention. Such a database can be provided, used and maintained in one or more databases in one or more locations. Databases are preferably stored in an appropriate format, such as a machine readable format. Databases are preferably provided and stored on a machine readable medium, such as a magnetic or optical medium. Databases can be made, maintained and used via appropriate hardware and software, such as are commercially available.

4. Results and Databases of Results

The present invention also includes results obtained using a method of the present invention, preferably provided in an appropriate format. Results obtained using methods of the present invention can be provided as a database, wherein a database that includes at least in part results obtained using a method of the present invention is itself an aspect of the present invention. Such a database can be provided, used and maintained in one or more databases in one or more locations. Databases are preferably stored in an appropriate format, such as a machine readable format. Databases are preferably provided and stored on a machine readable medium, such as a magnetic medium. Databases can be made, maintained and used via appropriate hardware and software, such as are commercially available.

5. Databases of Data and Results

The present invention also includes the combination of data and results obtained using a method of the present invention, preferably provided in an appropriate format. Data and results obtained using a method of the present invention can be provided as a database, wherein a database that includes at least in part data and results obtained using a method of the present invention is itself an aspect of the present invention. Such a database can be provided, used and maintained in one or more databases in one or more locations. Databases are preferably stored in an appropriate format, such as a machine readable format. Databases can be made, maintained and used via appropriate hardware and software, such as are commercially available.

6. A System for Obtaining Results for a Query

The present invention also includes a system for obtaining results of a query, that includes: a server including a server database, a link to a reference location, and a client linked to the server through a client system. Preferably, a query is provided by the client or client system to the server through the client system and data relating to the query is obtained. The data is optionally stored in whole or in part on the server. A response to the query is generated using, at least in part, software and the data and notice of the response is optionally made available to a client or client location. Preferably, the results are communicated to the client system using at least in part the data; optionally notifying a client remote system of the existence of the results; and obtaining the results through the client system.

This aspect of the present invention utilizes appropriate articles of manufacture, hardware, software and methods to form or compile a system to practice a method of the present invention. The components of the system need not be provided in a single geographical location or a single internet location, and are preferably provided in separate geographical and internet locations. The components of the system, in particular the hardware, is preferably obtained using commercially available sources. However, novel software can be designed as needed to perform a particular function.

### EXAMPLES

### Example I

### Queries for Information and Results for Providing Airline Flight Reservations

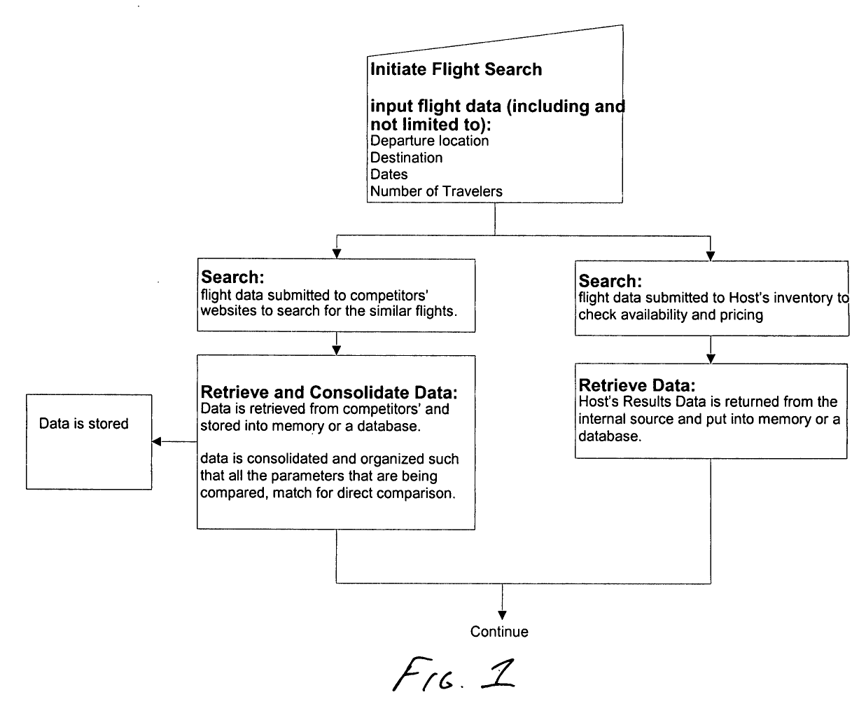

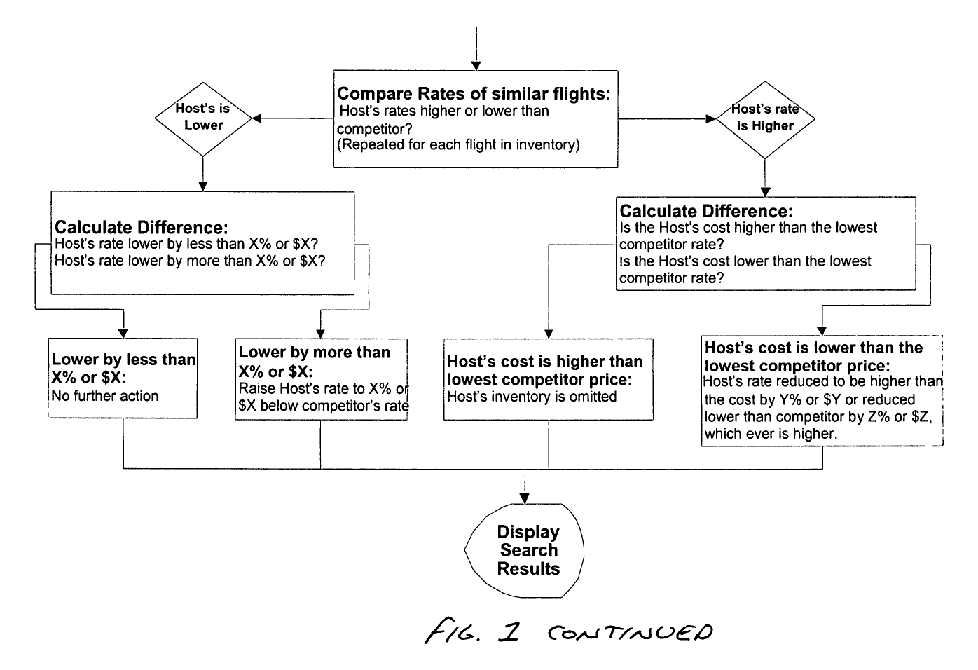

One aspect of the present invention is presented in FIG. 1, which diagrammatically describes the Variable Pricing Module system, used in a preferred aspect of the present invention. In this example the Variable Pricing Module system employs commonly available internet links to make database connectivity between locations such as a server, a client system and a reference location, and to enable the utilization of fast and highly responsive web-based search engines for data retrieval. The Variable Pricing Module system allows a user such as a client to conduct airline flight availability and cost research using a single query rather than the multiple-query approach as has previously been necessary.

A client system transmits a client's query as to flight departure time, destination arrival time, travel dates, and number of travelers to the server. The server transfers this information to the Variable Pricing Module, where the Variable Pricing Module initiates its search of both the host's inventory as well as multiple reference locations. Data is retrieved from the reference locations, including the inventory of the host. The data retrieved from the reference locations as well as the host's inventory is processed to determine the available flights that most closely match the client's query as to flight departure time, destination arrival time, travel dates, and number of travelers. The data retrieved from both the reference locations and the host's inventory is then stored into a database or memory.

Next, the data retrieved from both the reference locations as well as the host's inventory is analyzed to determine the flights that match the client-input parameters. These matches are then compared, those from the reference locations to those from the host's inventory, and the difference in price between them determined.

Referring to FIG. 1, the difference in price between the flights available through the reference locations and the flights available from the host's inventory is analyzed, and a response is generated according to host-input parameters X, Y, and Z.

X refers to the minimum amount in terms of percentage or actual currency amount the host's price is lower than the reference location's price. If the host's price is lower by less than X, then no further action is necessary, and the host's price may be communicated to the client system. If the host's price is lower than the reference location's price by more than X, then the host's price is raised such that the host's price is lower than the reference location's price by less than X. This adjusted host price may then be communicated to the client system.

Y refers to the difference between the host's cost and the host's price in terms of percentage or actual currency amount. If the host's price is higher than the price provided by the reference location, the reference location's price is compared to the host's cost. If the host's cost is lower than the reference location's price, the host's price may be reduced to reflect the host's cost plus Y. Alternatively, if the host's price is higher than the price provided by the reference location, and the host's cost is lower than the reference location's price, the host's price may be lowered to reflect the reference location's price minus Z, which refers to the amount, in terms of percentage or actual currency, by which the host wishes to “beat” the reference location's price. This price may then be communicated to the client system.

If the host's cost is higher than the lowest reference location price, then the host's inventory is omitted from the response. Alternatively, if the host's cost is higher than the lowest reference location price, both the host's inventory as well as the reference location price may be omitted from the response.

Particularly desirable aspects of the Variable Pricing Module system are accuracy, timeliness, and thoroughness. Individual commercial search engines are not always accurate, and are often hampered by their own limited access to information. In addition, this limited access to information creates a need to repeat searches on several engines, which in turn increases the time required for the search. In some fields, search results are only accurate for a short period due to rapid price fluctuations, and thus the longer it takes to complete a search, the less accurate the search becomes. Accuracy can be further compromised by the time required for data analysis, as comparing the various search results from hundreds of search engines to find the most appropriate option extends the time required to obtain relevant information. The Variable Pricing Module allows clients to search multiple sites by entering a single query. These instantaneous searches are necessary for an accurate comparison of prices to be made, as prices in this field change rapidly. The Variable Pricing Module also compares the results from the different search engines, and provides the client with the best price available at a given instant, whether the price is available through the host or through other means. The advantage to the host is the ability to provide flights at prices below that of competitors, while still maximizing their own profit. At the same time, it is unlikely any single host could provide the lowest price on all flights, because the Airlines themselves arrange special deals with certain providers; this prevents any single host from using the Variable Pricing Module to monopolize the industry.

### Example II

### Queries for Information and Results for Providing Hotel Rooms

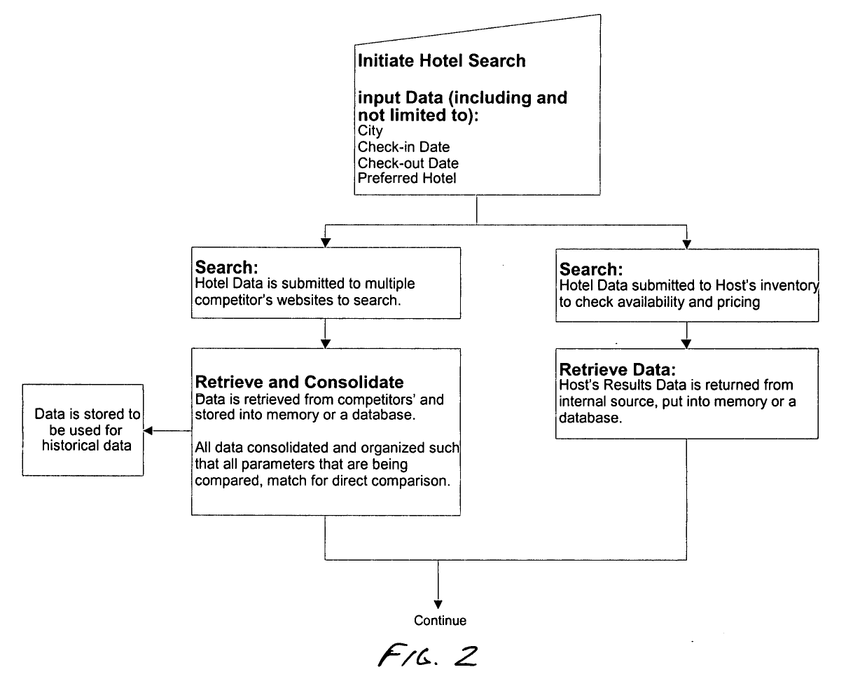

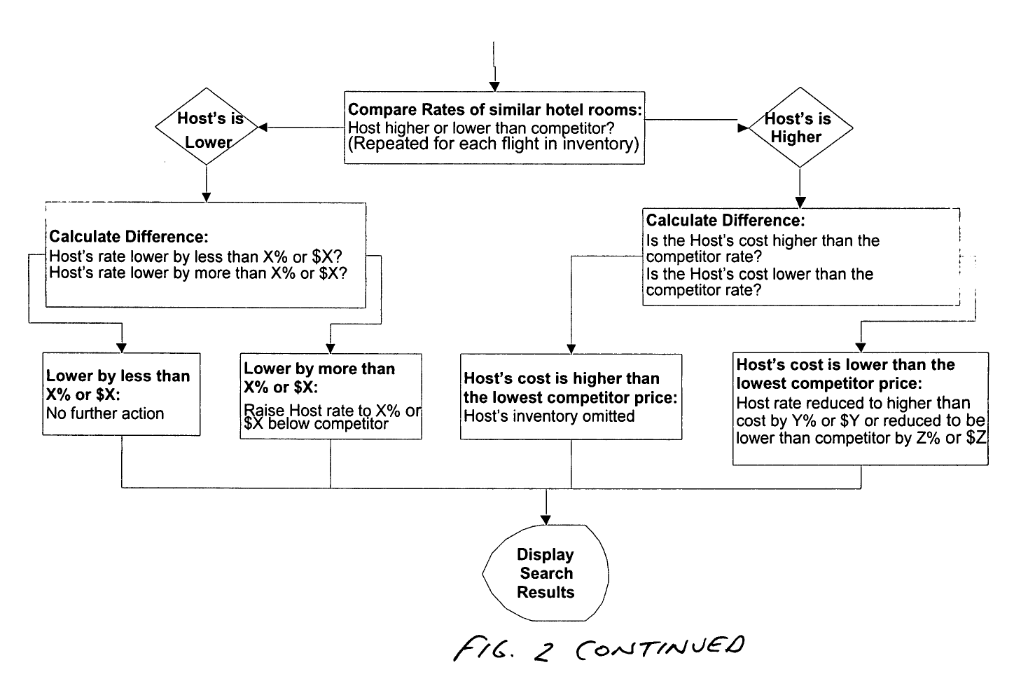

One aspect of the present invention is presented in FIG. 2, which diagrammatically describes the Variable Pricing Module system, used in a preferred aspect of the present invention. In this example the Variable Pricing Module system employs commonly available internet links to make database connectivity between locations such as a server, a client system and a reference location, and to enable the utilization of fast and highly responsive web-based search engines for data retrieval. The Variable Pricing Module system allows a user such as a client to conduct hotel room availability and cost research using a single query rather than the multiple-query approach as has previously been necessary.

A client system transmits a client's query as to hotel arrival time, hotel departure time, and number of travelers to the server. The server then transfers this information to the Variable Pricing Module, where the Variable Pricing Module initiates its search of both the host's inventory as well as multiple reference locations. Data is retrieved from the reference locations, including the inventory of the host. The data retrieved from the reference locations as well as the host's inventory is processed to determine the available hotel rooms that most closely match the client's query as to hotel arrival time, hotel departure time, and number of travelers. The data retrieved from both the reference locations and the host's inventory is then stored into a database or memory.

Next, the data retrieved from both the reference locations as well as the host's inventory is analyzed to determine the available hotel rooms that match the client-input parameters. These matches are then compared, those from the reference locations to those from the host's inventory, and the difference in price between them determined.

Referring to FIG. 2, the difference in price between the hotel rooms available through the reference locations and the hotel rooms available from the host's inventory is analyzed, and a response is generated according to host-input parameters X, Y, and Z.

X refers to the minimum amount in terms of percentage or actual currency amount the host's price is lower than the reference location's price. If the host's price is lower by less than X, then no further action is necessary, and the host's price may be communicated to the client system. If the host's price is lower than the reference location's price by more than X, then the host's price is raised such that the host's price is lower than the reference location's price by less than X. This adjusted host price may then be communicated to the client system.

Y refers to the difference between the host's cost and the host's price in terms of percentage or actual currency amount. If the host's price is higher than the price provided by the reference location, the reference location's price is compared to the host's cost. If the host's cost is lower than the reference location's price, the host's price may be reduced to reflect the host's cost plus Y. Alternatively, if the host's price is higher than the price provided by the reference location, and the host's cost is lower than the reference location's price, the host's price may be lowered to reflect the reference location's price minus Z, which refers to the amount, in terms of percentage or actual currency, by which the host wishes to “beat” the reference location's price. This price may then be communicated to the client system.

If the host's cost is higher than the lowest reference location price, then the host's inventory is omitted from the response. Alternatively, if the host's cost is higher than the lowest reference location price, both the host's inventory as well as the reference location price may be omitted from the response.

Particularly desirable aspects of the Variable Pricing Module system are accuracy, timeliness, and thoroughness. Individual commercial search engines are not always accurate, and are often hampered by their own limited access to information. In addition, this limited access to information creates a need to repeat searches on several engines, which in turn increases the time required for the search. In some fields, search results are only accurate for a short period due to rapid price fluctuations, and thus the longer it takes to complete a search, the less accurate the search becomes. Accuracy can be further compromised by the time required for data analysis, as comparing the various search results from hundreds of search engines to find the most appropriate option extends the time required to obtain relevant information. The Variable Pricing Module allows clients to search multiple sites by entering a single query. These instantaneous searches are necessary for an accurate comparison of prices to be made, as prices in this field change rapidly. The Variable Pricing Module also compares the results from the different search engines, and provides the client with the best price available at a given instant, whether the price is available through the host or through other means. The advantage to the host is the ability to provide hotel rooms at prices below that of competitors, while still maximizing their own profit. At the same time, it is unlikely any single host could provide the lowest price on all flights, because the hotel consolidators themselves arrange special deals with certain providers; this prevents any single host from using the Variable Pricing Module to monopolize the industry.

### Example III

### Queries for Information and Results for Providing Computer Memory

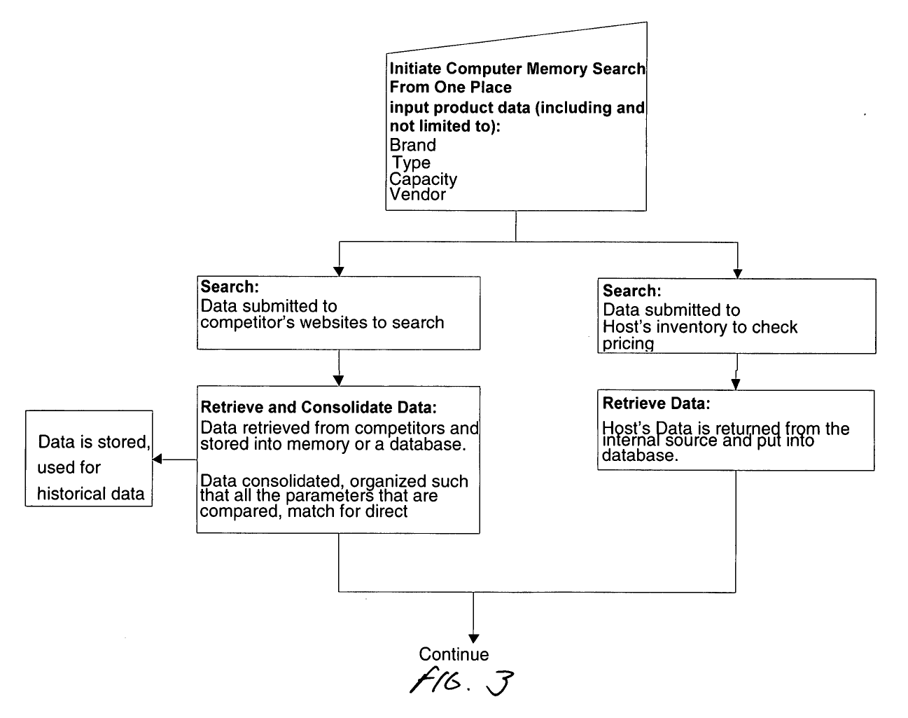

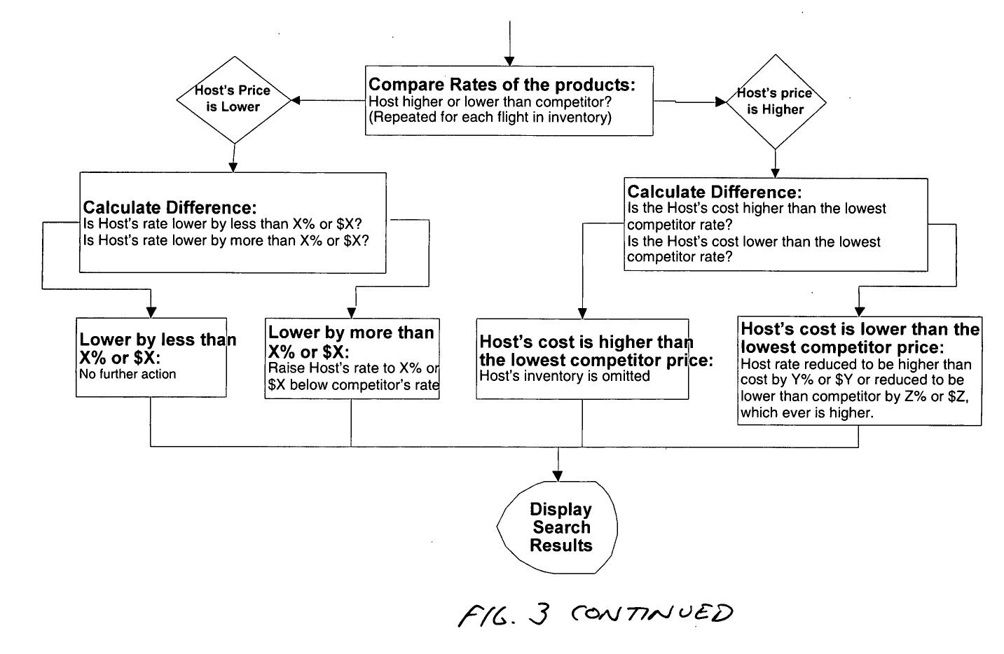

One aspect of the present invention is presented in FIG. 3, which diagrammatically describes the Variable Pricing Module system, used in a preferred aspect of the present invention. In this example the Variable Pricing Module system employs commonly available internet links to make database connectivity between locations such as a server, a client system and a reference location, and to enable the utilization of fast and highly responsive web-based search engines for data retrieval. The Variable Pricing Module system allows a user such as a client to conduct computer memory availability and cost research using a single query rather than the multiple-query approach as has previously been necessary.

A client system transmits a client's query as to memory type and quantity to the server. The server then transfers this information to the Variable Pricing Module, where the Variable Pricing Module initiates its search of both the host's inventory as well as multiple reference locations. Data is then retrieved from the reference locations, including the inventory of the host. The data retrieved from the reference locations as well as the host's inventory is then processed to determine the available computer memory that most closely matches the client's query as to memory type and quantity. The data retrieved from both the reference locations and the host's inventory is then stored into a database or memory.

Next, the data retrieved from both the reference locations as well as the host's inventory is analyzed to determine the available computer memory that matches the client-input parameters. These matches are then compared, those from the reference locations to those from the host's inventory, and the difference in price between them determined.

Referring to FIG. 3, the difference in price between the computer memory available through the reference locations and the computer memory available from the host's inventory is analyzed, and a response is generated according to host-input parameters X, Y, and Z.

X refers to the minimum amount in terms of percentage or actual currency amount the host's price is lower than the reference location's price. If the host's price is lower by less than X, then no further action is necessary, and the host's price may be communicated to the client system. If the host's price is lower than the reference location's price by more than X, then the host's price is raised such that the host's price is lower than the reference location's price by less than X. This adjusted host price may then be communicated to the client system.

Y refers to the difference between the host's cost and the host's price in terms of percentage or actual currency amount. If the host's price is higher than the price provided by the reference location, the reference location's price is compared to the host's cost. If the host's cost is lower than the reference location's price, the host's price may be reduced to reflect the host's cost plus Y. Alternatively, if the host's price is higher than the price provided by the reference location, and the host's cost is lower than the reference location's price, the host's price may be lowered to reflect the reference location's price minus Z, which refers to the amount, in terms of percentage or actual currency, by which the host wishes to “beat” the reference location's price. This price may then be communicated to the client system.

If the host's cost is higher than the lowest reference location price, then the host's inventory is omitted from the response. Alternatively, if the host's cost is higher than the lowest reference location price, both the host's inventory as well as the reference location price may be omitted from the response.

Particularly desirable aspects of the Variable Pricing Module system are accuracy, timeliness, and thoroughness. Individual commercial search engines are not always accurate, and are often hampered by their own limited access to information. In addition, this limited access to information creates a need to repeat searches on several engines, which in turn increases the time required for the search. In some fields, search results are only accurate for a short period due to rapid price fluctuations, and thus the longer it takes to complete a search, the less accurate the search becomes. Accuracy can be further compromised by the time required for data analysis, as comparing the various search results from hundreds of search engines to find the most appropriate option extends the time required to obtain relevant information. The Variable Pricing Module allows clients to search multiple sites by entering a single query. These instantaneous searches are necessary for an accurate comparison of prices to be made, as prices in this field change rapidly. The Variable Pricing Module also compares the results from the different search engines, and provides the client with the best price available at a given instant, whether the price is available through the host or through other means. The advantage to the host is the ability to provide computer memory at prices below that of competitors, while still maximizing their own profit. At the same time, it is unlikely any single host could provide the lowest price on all types of computer memory, because vendors themselves have different costs when dealing with different manufacturers; this prevents any single host from using the Variable Pricing Module to monopolize the industry.

### Example IV

### Queries for Information and Results for Providing Printer Ink or Toner

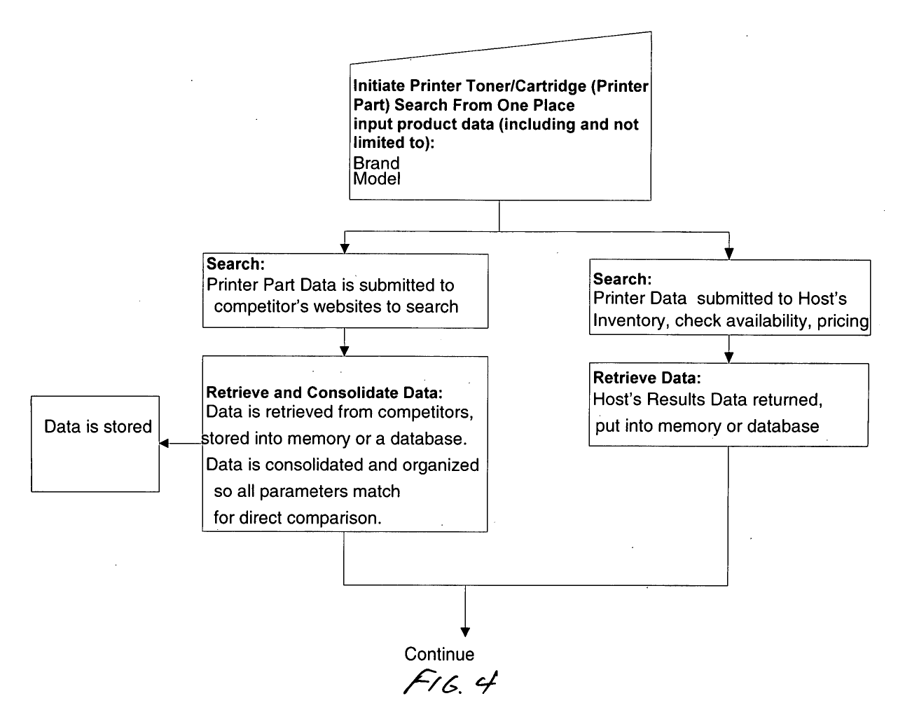

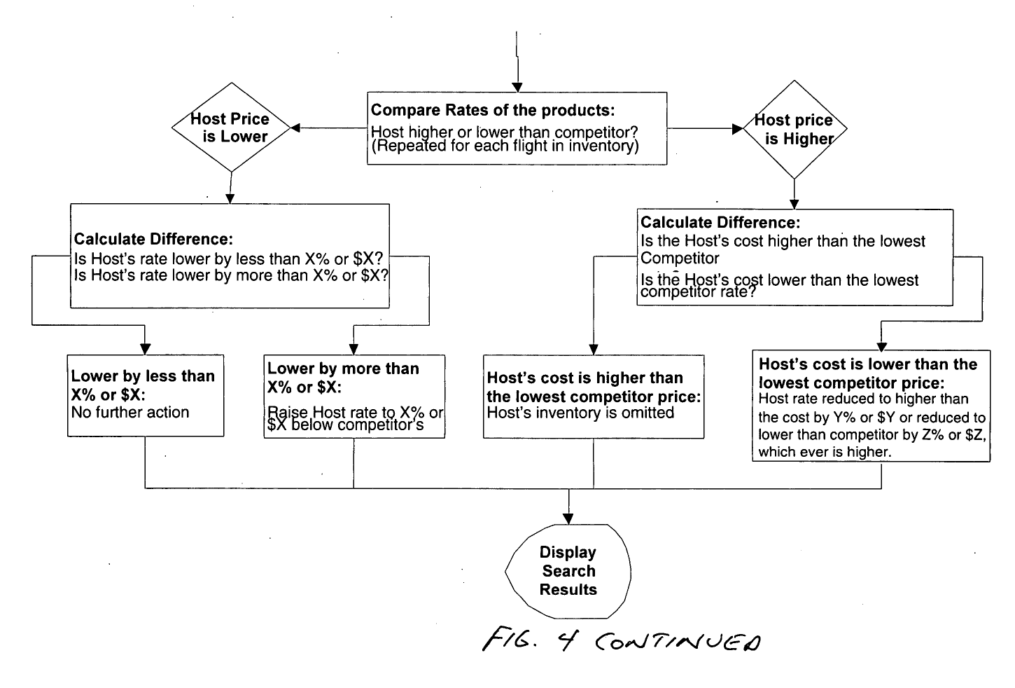

One aspect of the present invention is presented in FIG. 4, which diagrammatically describes the Variable Pricing Module system, used in a preferred aspect of the present invention. In this example the Variable Pricing Module system employed commonly available internet links to make database connectivity between locations such as a server, a client system and a reference location, and to enable the utilization of fast and highly responsive web-based search engines for data retrieval. The Variable Pricing Module system allows a user such as a client to conduct printer ink cartridge and toner availability and cost research using a single query rather than the multiple-query approach as has previously been necessary.

A client system transmits a client's query as to ink or toner type and quantity to the server. The server then transfers this information to the Variable Pricing Module, where the Variable Pricing Module initiates its search of both the host's inventory as well as multiple reference locations. Data is then retrieved from the reference locations, including the inventory of the host. The data retrieved from the reference locations as well as the host's inventory is then processed to determine the available ink or toner that most closely matches the client's query as to type and quantity. The data retrieved from both the reference locations and the host's inventory is then stored into a database or memory.

Next, the data retrieved from both the reference locations as well as the host's inventory is analyzed to determine the available ink or toner type and quantity that matches the client-input parameters. These matches are then compared, those from the reference locations to those from the host's inventory, and the difference in price between them determined.

Referring to FIG. 4, the difference in price between the ink or toner available through the reference locations and the ink or toner available from the host's inventory is analyzed, and a response is generated according to host-input parameters X, Y, and Z.

X refers to the minimum amount in terms of percentage or actual currency amount the host's price is lower than the reference location's price. If the host's price is lower by less than X, then no further action is necessary, and the host's price may be communicated to the client system. If the host's price is lower than the reference location's price by more than X, then the host's price is raised such that the host's price is lower than the reference location's price by less than X. This adjusted host price may then be communicated to the client system.

Y refers to the difference between the host's cost and the host's price in terms of percentage or actual currency amount. If the host's price is higher than the price provided by the reference location, the reference location's price is compared to the host's cost. If the host's cost is lower than the reference location's price, the host's price may be reduced to reflect the host's cost plus Y. Alternatively, if the host's price is higher than the price provided by the reference location, and the host's cost is lower than the reference location's price, the host's price may be lowered to reflect the reference location's price minus Z, which refers to the amount, in terms of percentage or actual currency, by which the host wishes to “beat” the reference location's price. This price may then be communicated to the client system.

If the host's cost is higher than the lowest reference location price, then the host's inventory is omitted from the response. Alternatively, if the host's cost is higher than the lowest reference location price, both the host's inventory as well as the reference location price may be omitted from the response.

Particularly desirable aspects of the Variable Pricing Module system are accuracy, timeliness, and thoroughness. Individual commercial search engines are not always accurate, and are often hampered by their own limited access to information. In addition, this limited access to information creates a need to repeat searches on several engines, which in turn increases the time required for the search. In some fields, search results are only accurate for a short period due to rapid price fluctuations, and thus the longer it takes to complete a search, the less accurate the search becomes. Accuracy can be further compromised by the time required for data analysis, as comparing the various search results from hundreds of search engines to find the most appropriate option extends the time required to obtain relevant information. The Variable Pricing Module allows clients to search multiple sites by entering a single query. These instantaneous searches are necessary for an accurate comparison of prices to be made, as prices in this field change rapidly. The Variable Pricing Module also compares the results from the different search engines, and provides the client with the best price available at a given instant, whether the price is available through the host or through other means. The advantage to the host is the ability to provide ink or toner at prices below that of competitors, while still maximizing their own profit. At the same time, it is unlikely any single host could provide the lowest price on all types of ink or toner, because vendors themselves have different costs when dealing with different manufacturers; this prevents any single host from using the Variable Pricing Module to monopolize the industry.

All publications, including patent documents, world wide web sites, book chapters, books and scientific articles, referred to in this application and set forth in the bibliography are incorporated by reference in their entirety for all purposes to the same extent as if each individual publication were individually incorporated by reference.

All headings are for the convenience of the reader and should not be used to limit the meaning of the text that follows the heading, unless so specified.

What is claimed is:

1. A method for determining a price, comprising:
providing a system for determining a price comprising;
a server comprising a server database, a processor, and a link to a reference location capable of providing information;
wherein said server is capable of communicating with a client system;
wherein said server is capable of accepting a query provided through said client system;
wherein said processor is capable of using said query and said link to search a plurality of reference locations, including the inventory of the host;
wherein said processor is capable of obtaining data relating to said query;
wherein said processor is capable of comparing said data from said plurality of reference locations and determining the price to be offered by the host based upon host-input parameters;
wherein said server is capable of communicating a response to said client system.

2. The method of claim 1, wherein said system is in whole or in part automated.

3. The method of claim 1, wherein said server is one or more servers in a single location or in multiple locations.

4. The method of claim 1, wherein said server is a secure server.

5. The method of claim 1, wherein said server is an encrypted server.

6. The method of claim 1, wherein said server database is one or more server databases in a single location or multiple locations.

7. The method of claim 1, wherein said link to a reference location is via the internet.

8. The method of claim 1, wherein said reference location comprises one or more locations.

9. The method of claim 1, wherein said client system comprises one or more locations.

10. The method of claim 1, wherein said query is input by a machine operator or a human operator.

11. The method of claim 1, wherein said query is input into a form.

12. The method of claim 1, wherein said query is an alphanumerical string.

13. The method of claim 1, wherein said query is stored on said server.

14. The method of claim 1, wherein said query is stored in a database.

15. The method of claim 1, wherein said data is obtained in whole or in part from said server database, said reference location, the internet or by investigatory methods.

16. The method of claim 1, wherein said data is generated by searching at least one of said server database, said reference location, the internet or by investigatory methods using automated methods, human operators or human searchers.

17. The method of claim 1, wherein said data is stored on said server.

18. The method of claim 1, wherein said response is provided in an electronic form.

19. The method of claim 1, wherein said response is obtained directly from said server.

20. A method of doing business, comprising:
providing a system for determining a price, comprising;
a server comprising a server database, a processor, and a link to a reference location capable of providing information;
wherein said server is capable of communicating with a client system;
wherein said server is capable of accepting a query provided through said client system;
wherein said processor is capable of using said query and said link to search a plurality of reference locations, including the inventory of the host;
wherein said processor is capable of obtaining data relating to said query;
wherein said processor is capable of comparing said data from said plurality of reference locations and determining the price to be offered by the host based upon host-input parameters;
wherein said server is capable of communicating a response to said client system.

21. The method of claim 20, wherein said system is in whole or in part automated.

22. The method of claim 20, further comprising charging a billing entity for said data or for said response.

23. A system for determining a price, comprising;
a server comprising a server database, a processor, and a link to a reference location capable of providing information;
wherein said server is capable of communicating with a client system;
wherein said server is capable of accepting a query provided through said client system;
wherein said processor is capable of using said query and said link to search a plurality of reference locations, including the inventory of the host;
wherein said processor is capable of obtaining data relating to said query;
wherein said processor is capable of comparing said data from said plurality of reference locations and determining the price to be offered by the host based upon host-input parameters;
wherein said server is capable of communicating a response to said client system

24. The system of claim 23, wherein said system is in whole or in part automated.

25. The system of claim 23, wherein said server is one or more servers in a single location or in multiple locations.

26. The system of claim 23, wherein said server is a secure server.

27. The system of claim 23, wherein said server is an encrypted server.

28. The system of claim 23, wherein said server database is one or more server databases in a single location or multiple locations.

29. The system of claim 23, wherein said link to a reference location is via the internet.

30. The system of claim 23, wherein said reference location comprises one or more locations.
